(19) United States
(12) Patent Application Publication
(10) Pub. No.: US 2023/0150592 A1
(43) Pub. Date: May 18, 2023

(54) IDLER FOR UNDERCARRIAGE SYSTEM IN TRACK-TYPE MACHINE AND WEAR PAD FOR SAME

(71) Applicant: Caterpillar Inc., Peoria, IL (US)

(72) Inventors: Michael Stephen Galat, Peoria, IL (US); Temitope O Akinlua, Peoria, IL (US)

(73) Assignee: Caterpillar Inc., Peoria, IL (US)

(21) Appl. No.: 17/529,512

(22) Filed: Nov. 18, 2021

(51) Int. Cl. B62D 55/14

(52) U.S. Cl. CPC B62D 55/145

(57) ABSTRACT

An idler for an undercarriage system in a track-type machine includes an idler rim having an outer rim surface extending around an idler axis of rotation, and a plurality of one-piece wear pads attached to the idler rim upon a first axial side and a second axial side of a radially projecting central guide flange. Each of the one-piece wear pads includes a sacrificial head supported on the outer rim surface, and having a base in interlocking engagement with the idler rim.

### TECHNICAL FIELD

The present disclosure relates generally to an idler in an undercarriage system of a track-type machine, and more particularly to one-piece replaceable idler wear pads for extending idler service life.

### BACKGROUND

Track-type machines are used throughout the world in a great many different off-highway applications. In a typical configuration each of two ground-engaging tracks in a machine includes an endless loop of track links in two parallel track chains extending about rotating elements including one or more idlers and a drive sprocket. Track shoes, commonly equipped with grousers, are attached to the track chains and contact a substrate to propel and steer the machine. In rough, uneven, rocky, steep, and slippery field service environments track-type machines are indispensable for many activities.

Due to the nature of substrate materials and service conditions, wear between and among components in an undercarriage system of a track-type machine can be relatively severe. In view of the wear phenomena, and the necessity for generally robust and sophisticated track and undercarriage construction, inspection, servicing, and replacement of undercarriage parts is routine. As noted above, one or more idlers are typically provided which rotate passively in contact with the track as the track advances during service. The idler is commonly arranged to rotate in contact with track rails formed by the parallel chains of track links. Over the course of time material of the contacting components tends to be worn away, eventually requiring replacement of the idler.

Various proposals are known for reuse, repair, and otherwise extending idler service life. In commonly owned U.S. Pat. No. 8,770,672 to Yelistratov, an undercarriage system includes an idler having a compound annular rim capping a hub and formed of a relatively higher hardness metallic material. The use of relatively higher hardness metallic material apparently is intended to extend idler service life, and the disclosed techniques can enable replacement of worn-away material in a used idler, for example. While Yelistratov may have various applications and advantages, there is always room for improvement and development of alternative strategies.

### SUMMARY

In one aspect, an idler for an undercarriage system in a track-type machine includes an idler rim having an outer rim surface extending circumferentially around an idler access of rotation and forming a radially projecting central guide flange. The idler further includes a plurality of one-piece wear pads attached to the idler rim upon a first axial side of the radially projecting central guide flange and upon a second axial side of the radially projecting central guide flange. Each of the plurality of one-piece wear pads includes a sacrificial head supported on the outer rim surface and having an outer link-contact surface, and a base in interlocking engagement with the idler rim.

In another aspect, an idler for an undercarriage system in a track-type machine includes an idler rim having an outer rim surface extending circumferentially around an idler axis of rotation, and an inner surface forming a shaft bore extending between a first axial idler side and a second axial idler side. The first axial idler side includes a first axial end face extending radially inward from the outer rim surface, and the second axial idler side includes a second axial end face extending radially inward from the outer rim surface. The idler rim further includes a plurality of pad retention channels arranged in a first set extending radially inward from the outer rim surface and axially inward from the first axial end face, and a second set extending radially inward from the outer rim surface and axially inward from the second axial end face.

In still another aspect, an idler wear pad for an idler in an undercarriage system includes a one-piece pad body having an elongate sacrificial head including an inner idler-contact surface, and an outer link-contact surface extending fore and aft between a first head end and a second head end and having an arcuate longitudinal profile that is upwardly convex. The one-piece pad body further includes a neck attached to the elongate sacrificial head longitudinally between the first head end and the second head end and extending downwardly from the inner idler-contact surface, and a base extending outwardly from the neck both fore and aft to interlock the one-piece pad body within a pad retention channel in an idler.

### BRIEF DESCRIPTION OF THE DRAWINGS

FIG. 1 is a side diagrammatic view of a portion of an undercarriage system in a track-type machine, according to one embodiment;

FIG. 2 is an assembled diagrammatic view of an idler, according to one embodiment;

FIG. 3 is a partially assembled diagrammatic view of an idler, as in FIG. 2;

FIG. 4 is an enlarged diagrammatic view of a portion of an idler as in FIGS. 2 and 3; and

FIG. 5 is a diagrammatic view of an idler wear pad, according to one embodiment.

### DETAILED DESCRIPTION

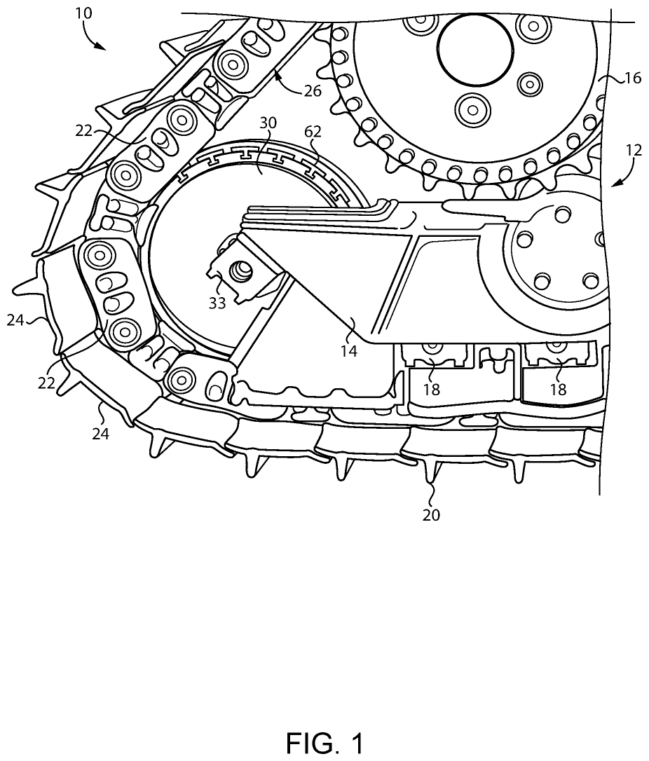

Referring to FIG. 1, there is shown a track-type machine 10 including an undercarriage system 12, according to one embodiment. Undercarriage system 12 includes a track roller frame 14, a drive sprocket 16, and a plurality of track rollers 18. A ground-engaging track 20 extends in an endless loop around drive sprocket 16, track rollers 18, and an idler 30. Idler 30 may be a back idler, or a front idler, in a so-called “high drive” track configuration” as shown, in an oval configuration, or still another. In a typical arrangement, track 20 and other components shown in FIG. 1 are on one side of machine 10, and analogous components arranged to provide a second ground-engaging track upon an opposite side of machine 10. Track 20 includes a plurality of coupled-together track links 22 with a plurality of attached track shoes 24. Track links 22 form a track rail 26 upon which idler 30 and track rollers 18 ride during service. Track rail 26 may be one of two track rails formed by two parallel track chains in track 20, one of which is visible and formed by track links 22 in the illustrated embodiment. Undercarriage system 12 can be used in a track-type tractor, a track-type loader, or any of a variety of other types of off-highway machines. In a practical implementation strategy machine 10 includes a track-type tractor as might be used for construction, mining, forestry, or a variety of other applications. As will be further apparent from the following description idler 30 is configured with replaceable wear parts for extended service life in undercarriage system 12.

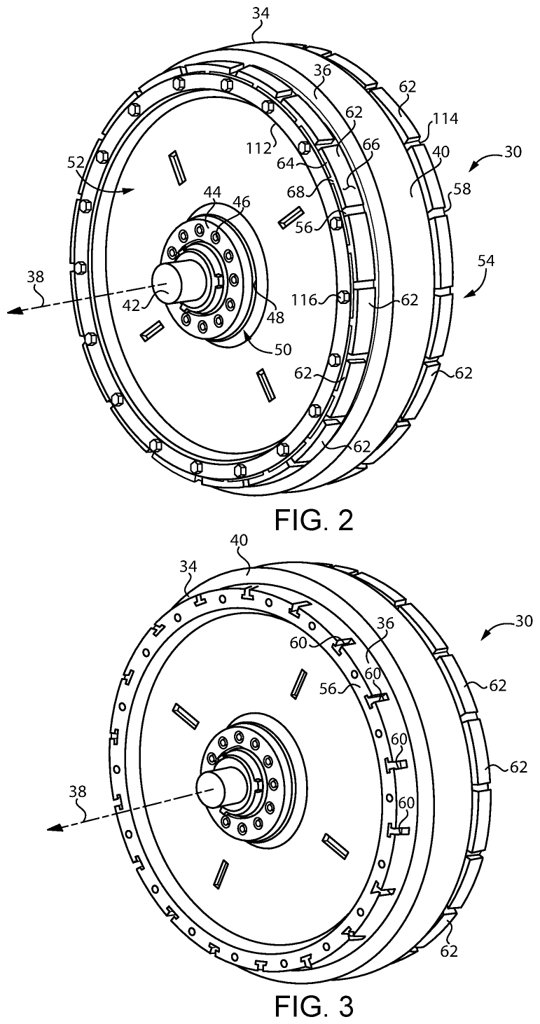

Referring also now to FIGS. 2 and 3, idler 30 includes an idler rim 34 having an outer rim surface 36 extending circumferentially around an idler axis of rotation 38 and forming a radially projecting central guide flange 40. Idler rim 34 may be a one-piece forging of a suitable iron, steel, or other alloy metallic material. During service, guide flange 40 may be received between parallel chains of track links 22 and assists in maintaining idler 30 and track 20 in a desired arrangement. Idler rim 34 may further include an inner surface 48 forming a shaft bore 50 extending between a first axial idler side 52 and a second axial idler side 54. First axial idler side 52 includes a first axial end face 56 extending radially inward from outer rim surface 36. Second axial idler side 54 includes a second axial end face 58 extending radially inward from outer rim surface 36. Idler rim 34 further includes a plurality of pad retention channels 60 arranged in a first set extending radially inward from outer rim surface 36 and axially inward from first axial end face 56. Pad retention channels 60 are also arranged in a second set extending radially inward from outer rim surface 36 and axially inward from second axial end face 58. As used herein, the terms “radially inward” and “radially outward” are used according to their common definitions relative to idler axis of rotation 38. The terms “axially inward” and “axially outward” are understood to mean directions along or parallel to idler axis of rotation 38 toward and away from, respectively, a geometric center point of idler 30 intersected by idler axis of rotation 38.

Idler 30 further includes a plurality of one-piece wear pads 62 attached to idler rim 34 upon a first axial side of radially projecting central guide flange 40 and upon a second axial side of radially projecting central guide flange 40. One-piece wear pads 62 may each include a forging, a casting, a cut segment of an elongate, shaped forging, for example, or any other suitable body made of a suitable metallic material. Wear pads 62 might also be heat treated or hardened by another process in some embodiments. The metallic material of wear pads 62 may be the same as the material of which idler rim 34 is made, or different. In some embodiments wear pads 62 may include or be formed entirely from a relatively harder material than idler rim 34. Each of the plurality of wear pads 62 includes a sacrificial head 64 supported on outer rim surface 36 and having an outer link-contact surface 66, and a base 68 in interlocking engagement with idler rim 34. Sacrificial head 64 may be elongate in a direction circumferentially around idle axis of rotation 38. The term “sacrificial” is used in reference to expected and intended wearing away of material of wear pads 62 during service, as further discussed herein.

Also shown in FIGS. 2 and 3 is an idler shaft 42 extending through shaft bore 50 and rotatable journaling idler 30. Idler shaft 42 will typically be a fixed shaft, with bearings supported between idler shaft 42 and idler rim 34. In other embodiments, idler shaft 42 could be a live shaft supported for rotation in undercarriage system 12 and rotatably fixed relative to idler rim 34. A clamping ring 44 or the like can be positioned upon each axial side of idler rim 34 and bolted to idler rim 34 by way of bolts 46 to house and retain thrust and journal bearings, seals, and/or other components within idler 30. As shown in FIG. 1, idler 30 can be supported in support blocks 32 or other suitable apparatus coupled to track roller frame 14.

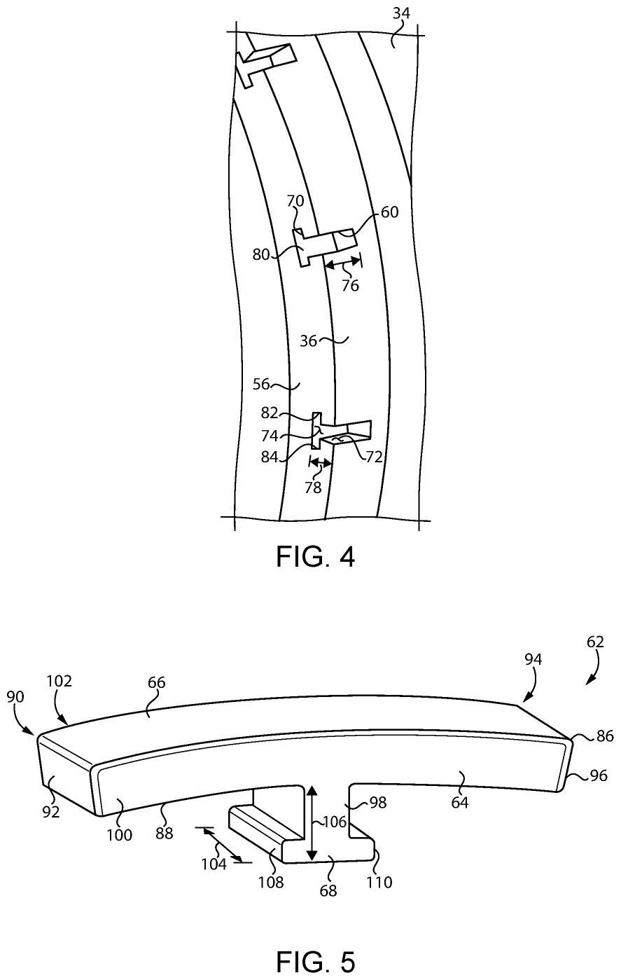

With focus on FIG. 3, each pad retention channel 60 may be formed in part by an undercut surface 70 facing a radially inward direction and spaced radially inward of outer rim surface 36. Each of pad retention channels 60 may also include a necked-down outer channel section 72 opening in outer rim surface 36 and in the respective first axial end face 56 or second axial end face 58, and an enlarged inner channel section 74. Pad retention channels 60 may be formed by machining, during forging, or by way of combination of these or other techniques. Enlarged channel section 74 may be formed in part by undercut surface 70 and opens in the respective first axial end face 56 or second axial end face 58. Referring also now to FIG. 4, in an implementation each of pad retention channels 60 further includes a channel floor 80 opposite to undercut surface 70, a forward recess 82, and a rearward recess 84. Each of pad retention channels 60 may further define an axial length dimension 76 and a radial depth dimension 78 that is equal to or less than axial length dimension 76. A number of pad retention channels 60 in each of the first set and the second set may be 8 or greater, in a refinement greater than 12, and regularly distributed circumferentially around idler axis of rotation 38.

As noted above, wear pads 62 each include a base 68 in interlocking engagement with idler rim 34. It is contemplated that a variety of different geometries of wear pads 62 and pad retention channels 60 could provide interlocking to secure wear pads 62 upon idler rim 34. Polygonal shapes of the respective bases and pad retention channels, non-polygonal shapes, L-shapes, T-shapes as shown, or still another could be employed. In a typical construction wear pads 62 are interlocking with idler rim 34 but removable. Thus, when it is desirable to replace wear pads 62, the used wear pads 62 can be slid out of pad retention channels 60 in axially outward directions and swapped out for new wear pads.

In the illustrated embodiment idler 30 further includes a first pad retainer 112 attached to first axial end face 56 and a second pad retainer 114 attached to second axial end face 58, each clamping or otherwise retaining a plurality of wear pads 62 within a plurality of pad retention channels 60. Also in the illustrated embodiment first pad retainer 112 and second pad retainer 114 are bolted to the respective first and second axial end face 56 and 58 by way of bolts 116. Other attachment strategies for wear pads 62 and/or pad retainers 112 and 114 could be used. For instance, wear pads 62 could be interference-fitted or spot welded. Analogously, pad retainers 112 and 114 could be bolted at locations radially inward from those shown, interference-fitted, or welded. Still other attachment strategies, including reversible and non-reversible attachment strategies, could be employed. A non-reversible attachment strategy would include a mechanism for attachment, which to overcome and decouple the parts, would require cutting or modifying components such that they are not reusable, at least without modification. As depicted in the drawings each of first pad retainer 112 and second pad retainer 114 may include one retaining ring. In other instances, arc segments of a ring, plates, covers, or another structure altogether could be used.

Referring also now to FIG. 5, there are shown features of a one-piece idler wear pad 62, according to the present disclosure, in further detail. Wear pad 62 includes outer link-contact surface 66 thereon as described above. Outer link-contact surface 66 may have an arcuate longitudinal profile. Sacrificial head 64 may also include an inner idler-contact surface 88 having an arcuate longitudinal profile parallel to the arcuate longitudinal profile of outer link-contact surface 66. Idler wear pad 62 may be formed as a one-piece pad body 86, wherein each of inner idler-contact surface 88 and outer link-contact surface 66 extends fore and aft between a first head end 90 having an end face 92 and a second head end 94 having an end face 96. A longitudinal cross-sectional shape of sacrificial head 64 may be a rectangular shape. The arcuate longitudinal profile of outer link-contact surface 66 may be upwardly convex, and the arcuate longitudinal profile of inner idler-contact surface 88 may be upwardly concave and matched to an outer profile of outer rim surface 36.

Idler wear pad 62 and one-piece pad body 86, referred to at times interchangeably herein, further includes a neck 98 attached to sacrificial head 64 longitudinally between first head end 90 and second head end 94 and extending downwardly from inner idler-contact surface 88. Base 68 may extend outwardly from neck 98 both fore and aft to interlock idler wear pad 62 within a pad retention channel 60 in idler 30. When interlocked with idler rim 34, neck 98 and base 68 may be entirely within idler rim 34, mostly or entirely axially inward of the respective axial end face 56 and 58. Sacrificial head 64 may likewise be mostly or entirely axially inward of the respective axial end face 56 and 58, and radially outward of outer rim surface 36. Sacrificial head 64 may be elongate in the fore and aft direction. When installed for service on idler rim 34 wear pads 62 may be arranged end-to-end upon the first axial side of central guide flange 40 and upon the second axial side of central guide flange 40. A number of wear pads 62 may be 8 or greater in some embodiments, and in a refinement greater than 12. Sacrificial head 64, neck 98, and base 68, together form a first planar side face 100 and a second planar side face 102 opposite to first planar side face 100, of one-piece pad body 86. A pad thickness dimension 104 is defined between first planar side face 100 and second planar side face 102. A head height dimension 106 that is equal to or less than pad thickness dimension 104 is defined between base 68 and inner idler-contact surface 88. Base 68 may include a forward projecting retention edge 108 and a rearward projecting retention edge 110, structured to fit into forward recess 82 and rearward recess 84, respectively. It can also be seen from the drawings, and FIG. 5 in particular, that neck 98 and base 68 together form a T-shape. Pad retention channels 60 may also have a T-shape, as noted above.

### INDUSTRIAL APPLICABILITY

Referring to the drawings generally, during service idler 30 will rotate with the advancement of track 20 in forward directions or reverse directions about the various track contacting rotatable elements in undercarriage system 12. Wear pads 62 will rotate in contact with track rail 26 and the track rail hidden from view in the illustration of FIG. 1, with contact between the materials of wear pads 62 and track links 22, as well as substrate particles and the like, causing material of wear pads 62 in each sacrificial head 64 to wear away. When undercarriage system 12 has reached a desired or a prescribed state of wear, undercarriage system 12 can be disassembled, and idler 30 removed. It is contemplated that wear pads 62 can be swapped out for new wear pads prior to each sacrificial head 64 wearing away entirely, although the present disclosure is not thereby limited. Attachment of first pad retainer 112 and second pad retainer 114 can be reversed, wear pads 62 slid out of pad retention channel 60, and replacement wear pads installed in their place. Pad retainers 112 and 114, or replacement pad retainers, can then be reinstalled in idler 30 to secure the replacement wear pads and idler 30 reassembled in undercarriage system 12.

The present description is for illustrative purposes only, and should not be construed to narrow the breadth of the present disclosure in any way. Thus, those skilled in the art will appreciate that various modifications might be made to the presently disclosed embodiments without departing from the kill and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. An idler for an undercarriage system in a track-type machine comprising:
an idler rim including an outer rim surface extending circumferentially around an idler axis of rotation and forming a radially projecting central guide flange;
a plurality of one-piece wear pads attached to the idler rim upon a first axial side of the radially projecting central guide flange and upon a second axial side of the radially projecting central guide flange; and
each of the plurality of one-piece wear pads including a sacrificial head supported on the outer rim surface and having an outer link-contact surface, and a base in interlocking engagement with the idler rim.

2. The idler of claim 1 wherein the outer link-contact surface has an arcuate longitudinal profile, and the sacrificial head includes an inner idler-contact surface having an arcuate longitudinal profile parallel to the arcuate longitudinal profile of the outer link-contact surface.

3. The idler of claim 2 wherein the sacrificial head is elongate in a direction circumferentially around the idler axis of rotation.

4. The idler of claim 3 wherein the plurality of wear pads are arranged end-to-end upon the first axial side of the radially projecting central guide flange and upon the second axial side of the radially projecting central guide flange.

5. The idler of claim 4 wherein a number of the plurality of wear pads is 8 or greater.

6. The idler of claim 1 wherein the idler rim includes a first axial end face, and a second axial end face, and a plurality of pad retention channels each receiving one of the plurality of one-piece wear pads extend radially inward from the outer rim surface and axially inward from a respective one of the first axial end face and the second axial end face.

7. The idler of claim 6 wherein each of the pad retention channels is formed in part by an undercut surface spaced radially inward of the outer rim surface.

8. The idler of claim 7 further comprising a first pad retainer and a second pad retainer attached to the first axial end face and the second axial end face, respectively, and each clamping a plurality of the one-piece wear pads within a plurality of the pad retention channels.

9. The idler of claim 8 wherein each of the first pad retainer and the second pad retainer includes a retaining ring.

10. An idler for an undercarriage system in a track-type machine comprising:
an idler rim including an outer rim surface extending circumferentially around an idler axis of rotation, and an inner surface forming a shaft bore extending between a first axial idler side and a second axial idler side;
the first axial idler side including a first axial end face extending radially inward from the outer rim surface, and the second axial idler side including a second axial end face extending radially inward from the outer rim surface; and
the idler rim further including a plurality of pad retention channels arranged in a first set extending radially inward from the outer rim surface and axially inward from the first axial end face, and a second set extending radially inward from the outer rim surface and axially inward from the second axial end face.

11. The idler of claim 10 wherein the plurality of pad retention channels are each formed in part by an undercut surface spaced radially inward of the outer rim surface.

12. The idler of claim 11 wherein each of the plurality of pad retention channels includes a necked-down channel section opening in the outer rim surface, and an enlarged channel section formed in part by the undercut surface and opening in the respective first axial end face or second axial end face.

13. The idler of claim 12 wherein each of the plurality of pad retention channels has a T-shape.

14. The idler of claim 12 wherein each of the plurality of pad retention channels defines an axial length dimension and a radial depth dimension that is equal to or less than the axial length dimension.

15. The idler of claim 10 wherein a number of the pad retention channels in each of the first set and the second set is 8 or greater and regularly distributed circumferentially around the idler axis of rotation.

16. An idler wear pad for an idler in an undercarriage system comprising:
a one-piece pad body including an elongate sacrificial head having an inner idler-contact surface, and an outer link-contact surface extending fore and aft between a first head end and a second head end and having an arcuate longitudinal profile that is upwardly convex; and
the one-piece pad body further including a neck attached to the elongate sacrificial head longitudinally between the first head end and the second head end and extending downwardly from the inner idler-contact surface, and a base extending outwardly from the neck both fore and aft to interlock the one-piece pad body within a pad retention channel in an idler.

17. The idler wear pad of claim 16 wherein:
the elongate sacrificial head, the neck, and the base, together form a first planar side face and a second planar side face opposite to the first planar side face, of the one-piece pad body; and
a pad thickness dimension is defined between the first planar side face and the second planar side face, and a head height dimension that is equal to or less than the pad thickness dimension is defined between the base and the inner idler-contact surface.

18. The idler wear pad of claim 17 wherein the base includes a forward projecting retention edge and a rearward projecting retention edge.

19. The idler wear pad of claim 18 wherein the neck and the head together form a T-shape.

20. The idler wear pad of claim 16 wherein the inner idler-contact surface has an arcuate longitudinal profile that is upward concave and parallel to the arcuate longitudinal profile of the outer link-contact surface.
